(19) United States
(12) Patent Application Publication
(10) Pub. No.: US 2015/0323318 A1
(43) Pub. Date: Nov. 12, 2015

(54) DEVICE AND METHOD FOR GENERATIVE PRODUCTION OF AT LEAST ONE COMPONENT AREA OF A COMPONENT

(71) Applicant: MTU Aero Engines AG, Muenchen (DE)

(72) Inventors: Thomas HESS, Muenchen (DE); Alexander LADEWIG, Bad Wiessee (DE); Steven PIORUN, Muenchen (DE); Guenter ZENZINGER, Waakirchen (DE)

(73) Assignee: MTU Aero Engines AG, Muenchen (DE)

(21) Appl. No.: 14/707,419

(22) Filed: May 8, 2015

(30) Foreign Application Priority Data
May 9, 2014 (EP) 14167697.3

(51) Int. Cl. G01B 11/30; G01B 11/00; H04N 13/02; H04N 5/225; H04N 5/33; B64F 5/00

(52) U.S. Cl. CPC G01B 11/30; H04N 5/332; B64F 5/0045; H04N 13/0207; H04N 5/2256; G01B 11/002

(57) ABSTRACT

A device for generative production of at least one component area of a component, in particular a component of a turbine or a compressor, is disclosed. The device includes at least one powder feed for application of at least one powder layer to a build-up and joining zone of a component platform that can be lowered and at least one radiation source for generating at least one high-energy beam by which the powder layer can be fused and/or sintered locally in the area of the build-up and joining zone to form a component layer. The device further includes a camera system which can produce at least one stereoscopic image for three-dimensional detection of at least one area of the component layer. A method for producing at least one component region of a component, in particular a component of a turbine or a compressor, is also disclosed.

This application claims the priority of European Patent Application No. EP 14167697.3, filed May 9, 2014, the disclosure of which is expressly incorporated by reference herein.

### BACKGROUND AND SUMMARY OF THE INVENTION

The invention relates to a device and a method for generative production of at least one component area of a component, in particular a component of a turbine or a compressor.

Methods and devices for producing components are known in a great variety. In particular generative manufacturing methods (so-called rapid manufacturing and/or rapid prototyping methods) in which the component is constructed layer-by-layer by additive manufacturing methods based on a powder bed are known. Mainly metallic components can be manufactured, for example, by laser and/or electron beam fusion or sintering methods in which at least one powdered component is first applied to a component platform in the region of a build-up and joining zone of the device. Next the component material is fused and/or sintered locally layer-by-layer by supplying energy by at least one high-energy beam, for example, an electron beam or a laser beam to the component material in the region of the build-up and joining zone. The high-energy beam is controlled as a function of layer information on the respective component layer to be produced. After being fused and/or sintered, the component platform is lowered layer-by-layer by a predefined layer thickness. Next the steps defined above are repeated until the final completion of the component.

It can be regarded as a disadvantage of the known devices and methods that information about the surface properties and/or morphology of the individual component layers and thus a precise determination of any defects in the finished component are possible only to a limited extent. In particular disturbances during the manufacturing process can be detected only indirectly by melt bath monitoring, vibration analysis of the powder application mechanism or optical tomography. Direct surface testing however, is possible only offline, i.e., with an interruption in the manufacturing process. This results in longer production times and high production costs accordingly.

The object of the present invention is to create a device and a method of the type defined in the introduction to permit an improved evaluation of the surface properties of individual component layers.

An initial aspect of the invention relates to a device for generative production of at least one component region of a component, in particular a component of a turbine or a compressor. This device includes at least one powder feed for application of at least one powder layer to a build-up and joining zone of a component platform that can be lowered and at least one radiation source for generating at least one high-energy beam, by which the powder layer can be fused and/or sintered locally in the region of the build-up and joining zone to form a component layer. According to the invention, the device allows an improved evaluation of the morphology of a component layer that is produced. This is done by providing a camera system by which at least one stereoscopic recording can be created for three-dimensional detection of at least one region of the component layer. The invention is based on the finding that disturbances in the generative manufacturing process will result in changes in the surface of the melt bath and thus in the subsequent component layer. These changes are suspected of causing structural defects. With the help of the camera system, it is now possible to detect the surface of any component layer with a particularly rapid and precise method, where the camera system generates “stereo images,” i.e., three-dimensional image information, that permits a particularly simple, rapid and accurate process control. The device according to the invention is suitable in particular for producing components for compressors or turbines of gas turbines, for example, baffles or blades on aircraft engines.

In an advantageous embodiment of the invention, it is provided that the camera system consists of at least two cameras, spaced a distance apart from one another. In other words, the camera system has at least two cameras, which are positioned at a constant or variable distance from one another and thus permit photographic recording of a 3D scene. From the spatial offset of the at least two images, it is possible to obtain 3D information, which allows conclusions to be drawn about the surface properties of the respective component layer. The depth maps obtained in this way can be used for 3D analysis as well as for visualization of the component surface and/or selected properties of the component surface. The at least two cameras and/or image sensors are preferably arranged so that they are axially parallel to one another with a horizontal distance between them. Fundamentally, instead of a second complete camera, an optical aid that replaces the second camera and/or two lens systems installed in a camera housing may also be provided with two respective image sensors and/or image sensor regions.

Additional advantages are obtained when the camera system is designed as a strip projection system. Image sequences can be generated in this way and used for three-dimensional detection of the surface properties of the component layer. In the case of a camera system designed as a strip projection system, the component layer, which has already been produced completely or is in the process of being produced can be illuminated with patterns of parallel light and dark strips of different widths sequentially in time using a camera system designed as a strip projection system. The camera(s) of the camera system record the strip pattern projected at a known angle of view to the projection. An image is recorded for each projection pattern, so that a chronological sequence of different brightness values is obtained for each image point, i.e., pixel, of all cameras. The three-dimensional coordinates of the surface of the component layer can then be derived from these brightness values.

In another advantageous embodiment of the invention, it is provided that the camera system includes at least one infrared sensor. A great independence of ambient light conditions is achieved in this way because the surfaces of generatively produced component layers made of metallic materials are usually highly reflective. In addition to depth information and/or image information, thermal information from the component layer thus formed can also be taken into account in evaluation of the surface properties. The infrared sensor may be designed as a CMOS and/or sCMOS and/or CCD camera. Detectors and/or cameras of the aforementioned types are capable of replacing most available CCD image sensors. In comparison with the previous generations of CCD-based sensors and/or cameras, cameras based on CMOS and sCMOS sensors offer various advantages, such as, for example, a very low readout noise, a high image rate, a large dynamic range, high quantum efficiency, a high resolution as well as a large sensor area. This permits especially good quality testing of the component layer thus produced. The infrared sensor can also be combined with additional sensors and/or cameras.

In another advantageous embodiment of the invention, the camera system is in a stationary position and/or is movable with respect to the build-up and joining zone. The camera system can be positioned optimally in this way as a function of the respective component and/or the specific design of the device. Furthermore, particularly simple images can be recorded from different angles of view because the camera system is positioned movably and these images can then be used to determine and evaluate the surface geometry of the component layer.

Additional advantages are derived by assigning an illumination system to the camera system, such that at least one region of the component layer can be illuminated at different angles of illumination and/or with different wavelengths and/or wavelength ranges by this illumination system. Since the surfaces of generatively produced component layers made of metallic materials are usually highly reflective, particularly precise determination of the surface properties of the respective component layer can be ensured as a function of the respective circumstances by multiple exposures with stationary cameras at different illumination angles and/or by illumination at wavelengths and/or wavelength ranges that vary over time and/or space.

In another embodiment of the invention, it has proven advantageous if the illumination system includes at least one infrared light source, in particular an IR laser and/or at least one light source by which at least the component layer can be illuminated sequentially over time with strips of different widths. This also permits a particularly precise determination of the surface properties of the respective component layer.

In another advantageous embodiment of the invention, the camera system is designed to create a plurality of recorded images of a single component layer. The signal-to-noise ratio can be improved advantageously in this way. Alternatively or additionally, even very large and/or geometrically demanding surfaces can also be determined and evaluated reliably.

Additional advantages are obtained by linking the camera system to an evaluation device, where the evaluation device is designed to ascertain the surface quality of the component layer on the basis of the at least one stereoscopic image of the camera system. The camera system and the evaluation device are preferably designed to ascertain and monitor the surface quality continuously even during the production of the component layer, so that when there are deviations from a target value, the appropriate corrections can be made even during the production of the individual component layers. Complex reworking or discarding of defective components can be reduced advantageously or even eliminated completely in this way.

Another aspect of the invention relates to a method for producing at least one component area of a component, in particular a component of a turbine or compressor, where the method includes at least the steps of applying at least one powdered component material to a component platform in the area of a build-up and joining zone, layer-by-layer and local fusion and/or sintering of the component material by input of energy by at least one high-energy beam in the area of the build-up and joining zone for forming a component layer, layer-by-layer lowering of the component platform by a predefined layer thickness and repeating these steps until the component area has been created. According to the invention, this method permits an improved evaluation of the morphology of a component layer that has been produced, because at least one stereoscopic image is created by a camera system for three-dimensional detection of at least one area of the component layer. The resulting advantages are described in the descriptions of the first aspect of the invention, where advantageous embodiments of the first aspect of the invention can be regarded as advantageous embodiments of the second aspect of the invention and vice versa.

In an advantageous embodiment of the invention, it is provided that at least one stereoscopic image is created by the camera system for a plurality of component layers and/or each individual component layer. This allows particularly reliable monitoring of the structure of the component produced by a generative process.

Additional advantages are derived by ascertaining the surface quality of the respective component layer on the basis of the at least one stereoscopic image. In other words, it is provided according to the invention that conclusions about the quality of the surface can be drawn from the three-dimensional depth map thereby ascertained. This may be done, for example, on the basis of deviations between a target value and an actual value. In addition, there is the possibility that the input of energy is controlled via the at least one high-energy beam on the basis of the at least one stereoscopic image as a function of the topography and/or morphology ascertained for the fused and/or sintered component material.

Additional features of the invention are derived from the claims, the exemplary embodiment and the drawings. The features and combinations of features mentioned in the description above as well as the features and combination of features mentioned in the exemplary embodiment may be used not only in the respective combination given but also in other combinations without going beyond the scope of the invention.

### BRIEF DESCRIPTION OF THE DRAWINGS

FIG. 1 shows a basic diagram of an exemplary embodiment of a device according to the invention for production of a component; and

FIG. 2 shows a basic diagram of determining stereoscopic images.

### DETAILED DESCRIPTION OF THE DRAWINGS

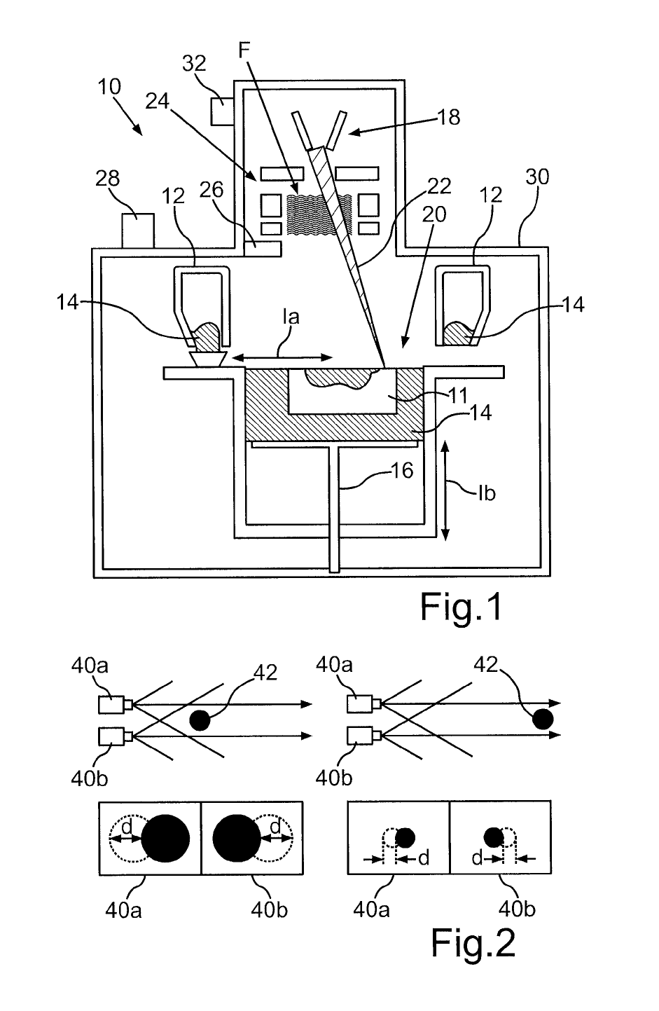

FIG. 1 shows a basic diagram of an exemplary embodiment of a device 10 according to the invention for producing a component 11, which is provided in the present case for use in a turbo engine. The same elements or those having the same function are labeled below with the same reference numerals. Component 11 in the exemplary embodiment shown here is a hollow structural component of a turbine. The device 10 includes a powder feed 12, which is movable according to the double arrow Ia, for application of at least one powdered component material 14 to a component platform 16 that is movable according to the double arrow Ib. In addition, the device 10 includes one or more radiation sources 18 by which laser beams and/or electron beams 22 can be generated for layer-by-layer and local fusion and/or sintering of the component material 14 in the region of a build-up and joining zone 20 of the component platform 16. To adjust the spatial deflection, the focusing and the thermal power of the electron beams 22, the device 10 may have a unit 24 for generating electromagnetic fields F as needed. Electron beams 22 of a radiation source 18 embodied as an electron source can be combined to form a beam—as shown in the present case—by the unit 24, separated from one another or split into a plurality of electron beams 22. Such a unit 24 is of course not necessary if one or more lasers are used to generate the high-energy beams 22.

The device 10 has a camera system 26 by which stereoscopic images can be created for three-dimensional detection of the component layers to monitor the production process. The arrangement of the camera system 26 here is just one example and is basically freely selectable. The camera system 26, which may fundamentally be designed to be stationary or movable, is linked to a fundamentally optional evaluation unit 28, where the evaluation unit 28 is designed to ascertain the surface quality of the individual component layers of the component 11 on the basis of the stereoscopic images of the camera system 26.

Two high-resolution cameras 40a, 40b (see FIG. 2), which make up the stereo camera system 26, permit a precise measurement of the surface of any component layer. The measurement principle may correspond to that of a strip projection, for example. Since the metallic surfaces produced by this rapid manufacturing method are highly reflective, various measures may be provided. For example, at least one of the cameras 40a, 40b may operate in the infrared range (IR range). Alternatively or additionally, multiple exposures of a component layer using stationary cameras 40a, 40b may be produced at different angles of illumination. It is also possible to provide that the component layer to be evaluated is illuminated with at least two light sources (not shown), where the light sources emit light of different wavelength ranges. It is likewise possible to provide that a laser of a radiation source 18, which is present anyway, may also be used as the light source.

To be able to produce the component 11 in the absence of oxygen and to avoid unwanted deflection of the high-energy beams 22, the device 10 may, if necessary, include a vacuum chamber 30, within which a high vacuum is created during production of the component 11.

To control the high-energy beams 22, the radiation source 18, the unit 24 and the evaluation device 28 are connected to a control and/or regulating device 32, which is designed to control and/or regulate the radiation source 18 as a function of the layer information about the component 11 to be produced and/or as a function of the surface properties and/or surface quality of the individual component layers thereby ascertained. The control and/or regulating device 32 thus allows a rapid and precise adaptation of the high-energy beams 22 to the properties of the respective component layer.

“Online monitoring” of the production process is available by detection and evaluation of the surface properties with the help of the camera system 26. This direct possibility for monitoring the fusion and/or sintering operation results in a high production speed with a high manufacturing precision at the same time.

Production of the component 11 is described below on the basis of the device 10. First, the powdered component material 14 is applied in the form of a layer to the component platform 16 in the area of the build-up and joining zone 20 with the help of the powder feed 12. Alternatively, a plurality of different component materials 14 can also be applied, with each component layer optionally being designed to be different. Next, the component material 14 is fused and/or sintered locally by layers by supplying energy through the high-energy beams 22. The energy supply through the high-energy beams 22 is controlled in the manner described above as a function of layer information about the component 11 and/or as a function of the topography and/or morphology of the fused and/or sintered component material 14, which is ascertained with the help of the camera system 26. After fusion and/or sintering, the component platform 16 is reduced by a predefined layer thickness. The aforementioned steps are then repeated until the component 11 is completed, whereupon each component layer is photographed, preferably with the help of the camera system 26, and evaluated with the help of the evaluation device 28 with respect to its surface quality.

FIG. 2 shows a basic diagram of determining stereoscopic images. For reconstruction of the depth information, at least two cameras 40a, 40b are used, as already mentioned, preferably being arranged so that they are axially parallel with a horizontal distance from one another. The so-called disparity d is obtained as the displacement between corresponding pixels of an object 42 from the respective projection geometry by using the beam set. With known camera parameters, the disparity is thus a unique measure of the object distance and can be used to ascertain a depth map for the 3D analysis and also for visualization of the surface of individual component layers as needed.

### LIST OF REFERENCE NUMERALS

10 device
11 component
12 powder feed
14 component material
16 component platform
18 radiation source
20 joining zone
22 high-energy beams
24 unit
26 camera system
28 evaluation device
30 vacuum chamber
32 regulating device
40a camera
40b camera
42 object

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for generative production of a component area of a component, comprising:
a powder feed, wherein a powder layer is applyable by the powder feed to a build-up and joining zone of a component platform that is lowerable;
a radiation source, wherein a high-energy beam is generatable by the radiation source and wherein the powder layer is fusable and/or sinterable locally in an area of the build-up and joining zone by the high-energy beam to form a component layer; and
a camera system, wherein a stereoscopic image of a region of the component layer is producible by the camera system for three-dimensional detection of the region of the component layer.

2. The device according to claim 1, wherein the camera system includes at least two cameras spaced a distance apart from one another.

3. The device according to claim 1, wherein the camera system is a strip projection system.

4. The device according to claim 1, wherein the camera system includes at least one infrared sensor.

5. The device according to claim 1, wherein the camera system is stationary and/or movable with respect to the build-up and joining zone.

6. The device according to claim 1 further comprising an illumination system, wherein at least one region of the component layer is illuminatable with different angles of illumination and/or with different wavelengths and/or wavelength ranges by the illumination system.

7. The device according to claim 6, wherein the illumination system includes at least one infrared light source and/or at least one light source wherein the component layer is illuminatable sequentially in time with strips of different widths by the at least one infrared light source and the at least one light source.

8. The device according to claim 7, wherein the at least one infrared light source is an IR laser.

9. The device according to claim 1, wherein a plurality of stereoscopic images of the component layer is producible by the camera system.

10. The device according to claim 1 further comprising an evaluation device connected to the camera system, wherein a surface quality of the component layer is ascertainable by the evaluation device on a basis of the stereoscopic image.

11. The device according to claim 1, wherein the component is a component of a turbine or of a compressor.

12. A method for producing a component region of a component, comprising the steps of:
a) application of a powdered component material to a component platform in an area of a build-up and joining zone of the component platform;
b) fusion and/or sintering of the powdered component material by supplying energy by a high-energy beam in the area of the build-up and joining zone to form a component layer;
c) lowering of the component platform by a predefined layer thickness;
d) repeating steps a) through c) to complete the component region; and
e) producing a stereoscopic image by a camera system of a region of the component layer for three-dimensional detection of the region of the component layer.

13. The method according to claim 12, wherein a respective stereoscopic image is produced for a plurality of component layers and/or for each component layer.

14. The method according to claim 12, wherein a surface quality of the component layer is ascertained on a basis of the stereoscopic image.

15. The method according to claim 12, wherein the energy supplied by the high-energy beam is controlled on a basis of the stereoscope image.

16. The method according to claim 12, wherein the component is a component of a turbine or of a compressor.
